(19) United States
(12) Patent Application Publication
(10) Pub. No.: US 2026/0176994 A1
(43) Pub. Date: Jun. 25, 2026

(54) METHODS OF DEPOSITING INORGANIC PARTICLES

(71) Applicant: CORNING INCORPORATED, CORNING, NY (US)

(72) Inventors: He Jing, Clayton, MO (US); Benedict Yorke Johnson, Horseheads, NY (US)

(21) Appl. No.: 19/127,570

(22) PCT Filed: Nov. 27, 2023
(86) PCT No.: PCT/US2023/081127

§ 371 Date: May 6, 2025

Related U.S. Application Data
(60) Provisional application No. 63/428,616, filed on Nov. 29, 2022.

(51) Int. Cl. F01N 3/022; B01D 46/24

(52) U.S. Cl. CPC F01N 3/0222; B01D 46/24491; B01D 46/24492; B01D 46/2476; B01D 46/2482

(57) ABSTRACT

Methods for providing inorganic deposits, such as refractory oxide nanoparticles, on a surface, such as a porous surface of a substrate, such as a porous substrate having interconnected pores that permit gas flow therethrough, the method comprising: combining inorganic particles, an organic solvent, a silane binder, and an organic acid such as citric acid into a suspension; aerosolizing at least a portion of the suspension into droplets; evaporating the organic solvent from the droplets to form agglomerates of the primary particles such as nanoparticles, the organic solvent, the silane binder, and the citric acid from the droplets; depositing the agglomerates onto the substrate; and curing the silane binder on the substrate to form a network of inorganic particles bound to the substrate as inorganic deposits.

### CROSS REFERENCE TO RELATED APPLICATION

This application claims the benefit of priority under 35 U.S.C. § 119 of U.S. Provisional Application Ser. No. 63/428,616, filed on Nov. 29, 2022, the content of which is relied upon and incorporated herein by reference in its entirety.

### BACKGROUND

### Field

The present specification relates to methods of depositing inorganic particles onto a surface, such as surfaces of porous ceramic honeycomb bodies.

### Technical Background

Wall-flow filters are employed to remove particulates from fluid exhaust streams, such as from combustion engine exhaust. Examples include diesel particulate filters used to remove particulates from diesel engine exhaust gases and gasoline particulate filters (GPF) used to remove particulates from gasoline engine exhaust gases. Exhaust gas to be filtered enters inlet cells and passes through the cell walls to exit the filter via outlet channels, with the particulates being trapped on or within the inlet cell walls as the gas traverses and then exits the filter.

### SUMMARY

Aspects of the disclosure pertain to methods of depositing inorganic particles onto a surface, such as surfaces of porous ceramic honeycomb filter bodies as well as the porous filter bodies containing the inorganic particles.

In one aspect, methods are disclosed herein for providing inorganic deposits, such as refractory oxide nanoparticles, on a surface, such as a porous surface of a substrate, such as a porous substrate having interconnected pores that permit gas flow therethrough, the method comprising: combining inorganic particles, an organic solvent, a silane binder, and an organic acid such as citric acid into a suspension; aerosolizing at least a portion of the suspension into droplets; evaporating the organic solvent from the droplets to form agglomerates of the primary particles such as nanoparticles, the organic solvent, the silane binder, and the citric acid from the droplets; depositing the agglomerates onto the substrate; and curing the silane binder on the substrate to form a network of inorganic particles bound to the substrate as inorganic deposits.

In embodiments, the inorganic particles comprise silicon-containing particles and aluminum-containing particles. In embodiments, the inorganic particles comprise silica-containing particles and alumina-containing particles. In embodiments, the inorganic particles consist essentially of silica particles and alumina particles. In embodiments, the inorganic particles comprise nanoparticles.

In embodiments, the inorganic particles are oxide particles. In embodiments, the inorganic particles are metal oxide particles. In embodiments, the inorganic particles are refractory nanoparticles.

In embodiments, the curing step comprises hydrolyzing the silane binder and grafting the hydrolyzed silane binder, for example comprising hydrolysis products of the silane binder, to the inorganic particles. In embodiments, the grafting creates a cross-linked network of inorganic particles.

In embodiments, the curing is performed in the presence of a curing catalyst. In embodiments, the curing catalyst is an organic acid. In embodiments, the organic acid is citric acid.

In embodiments, the curing catalyst is present in the suspension. In embodiments, the curing catalyst is present in the droplets. In embodiments, the curing catalyst is present in the agglomerates.

In embodiments, the curing step comprises cross-linking the silane binder.

In embodiments, the suspension comprises a catalytic amount of the organic acid. In embodiments, the suspension comprises no more than a catalytic amount of the organic acid.

In embodiments, the curing comprises heating the agglomerates deposited on the substrate. In embodiments, the curing comprises hydrolyzing and grafting the silane binder to the oxide nanoparticles

In embodiments, the organic solvent is an alcohol. In embodiments, the organic solvent is selected from the group consisting of ethanol, methanol, isopropanol, and combinations thereof. In embodiments, the organic solvent comprises ethanol. In embodiments, the organic solvent is ethanol.

In embodiments, the silane binder comprises silane. In embodiments, the silane binder comprises an alkoxysilane (that is, at least one alkoxysilane), an alkyl alkoxysilane (that is, at least one alkoxysilane), or combinations thereof. In embodiments, the silane binder comprises at least one alkoxysilane. In embodiments, the silane binder comprises at least one methoxysilane, at least one ethoxysilane, or combinations thereof. In embodiments, the silane binder comprises methyltriethoxysilane (MTES), methyltrimethoxysilane (MTMS), or a combination thereof. In embodiments, the silane binder comprises methyltriethoxysilane (MTES). In embodiments, the silane binder is methyltriethoxysilane (MTES). In embodiments, the silane binder comprises methyltrimethoxysilane (MTMS). In embodiments, the silane binder is methyltrimethoxysilane (MTMS).

In embodiments, the droplets are conveyed toward the substrate by a carrier gas. In embodiments, the carrier gas comprises an inert gas. In embodiments, the carrier gas comprises nitrogen. In embodiments, the carrier gas consists essentially of nitrogen.

In embodiments, the agglomerates are spherical.

In embodiments, the network of inorganic particles comprises alumina particles and silica particles.

In embodiments, the network of inorganic particles forms a membrane on the substrate.

In embodiments, the substrate is a filter body. In embodiments, the agglomerates are deposited on a surface of the filter body by filter deposition. In embodiments, at least some of the agglomerates are disposed below the surface of the filter body. In embodiments, the filter body comprises a honeycomb body comprised of intersecting porous walls, and the surface is a surface of at least one of the porous walls.

In embodiments, the depositing step further comprises filter depositing the agglomerates on, in, or both on and in, a wall of the substrate.

In embodiments, the substrate comprises a plugged honeycomb body comprising intersecting porous walls extending from an inlet end to an outlet end of the body and defining axial channels, wherein plugs seal at least some of the channels, and the depositing step further comprises filter depositing the agglomerates on, in, or both on and in, a plurality of the walls of the honeycomb body.

In another aspect, methods are disclosed herein for providing inorganic deposits on a surface of a substrate, the method comprising: combining inorganic particles, an organic solvent, a silane binder, and an organic acid into a suspension; aerosolizing at least a portion of the suspension into droplets; evaporating the organic solvent from the droplets to form agglomerates of the, the organic solvent, the silane binder, and the citric acid from the droplets; depositing the agglomerates onto the substrate; and curing the silane binder on the substrate to form a network of inorganic particles bound to the substrate.

In another aspect, filter bodies are disclosed herein comprising a honeycomb body containing agglomerates of inorganic particles grafted to each other and to the honeycomb body with products of hydrolysis.

In embodiments, the honeycomb body comprises a honeycomb structure extending axially from a first face to a second face, the structure being comprised of a plurality of porous walls extending axially and having surfaces which define a plurality of axial channels, the walls having internal pores, wherein surfaces of the walls comprise surface openings to at least some of the internal pores.

In embodiments, the deposited amount of the first particles per volume of the honeycomb structure is in the range of 0.1 to 10.0 grams/liter.

In embodiments, the deposited amount of the first particles per volume of the honeycomb structure is less than 7.0 grams/liter.

In embodiments, the deposited amount of the first particles per volume of the honeycomb structure is less than 5.0 grams/liter.

In embodiments, the inorganic particles are comprised of a primary particle size in the range of 0.1 to 1 μm.

In embodiments, the porous walls of the honeycomb body have a surface porosity of 35% to 75%. In embodiments, the porous walls have a median pore size of 5 to 50 micrometers. In embodiments, the porous walls have a median pore size of 5 to 30 micrometers. In embodiments, the porous walls have a median pore size of 10 to 30 micrometers.

As used herein, the loading of the inorganic particles is reported in g/L, which is grams per overall exterior dimension volume of the honeycomb body in liters.

Additional features and advantages will be set forth in the detailed description, which follows, and in part will be readily apparent to those skilled in the art from that description or recognized by practicing the embodiments described herein, comprising the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically illustrates an embodiment of a process of depositing inorganic particles onto a surface as disclosed herein.

FIG. 2 schematically illustrates an apparatus for depositing inorganic particles onto honeycomb filter bodies as disclosed herein.

FIG. 3 schematically illustrates embodiments of processing steps as disclosed herein for forming alumina-silica based deposits on a surface of a substrate, such as a honeycomb body for a gasoline particulate filter.

### DETAILED DESCRIPTION

Reference will now be made in detail to embodiments of methods for forming honeycomb bodies comprising a porous honeycomb body comprising deposits on, or in, or both on and in, the porous ceramic walls of the honeycomb body matrix, embodiments of which are illustrated in the accompanying drawings. In embodiments the honeycomb body matrix is a honeycomb structure such as a monolithic honeycomb, for example as produced via extrusion through a honeycomb die; or in other embodiments the honeycomb body matrix comprises two or more blocks or segments of honeycomb matrix which are included or bound together such as by cement. Deposits may comprise material that was deposited into the honeycomb body, as well as compounds that may be formed, for example, by heating, from one or materials that were deposited. For example, a binder material may be transformed by heating and/or which may be eventually burned off or volatilized, while an inorganic component (such as alumina and/or silica) remains contained within the honeycomb filter body. Whenever possible, the same reference numerals will be used throughout the drawings to refer to the same or like parts.

### Definitions

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

As used herein, “have”, “having”, “include”, “including”, “comprise”, “comprising” or the like are used in their open-ended sense, and generally mean “including, but not limited to”.

A “honeycomb body,” as referred to herein, comprises a ceramic honeycomb structure of a matrix of intersecting walls that form cells which define channels. The ceramic honeycomb structure can be formed, extruded, or molded from a plasticized ceramic or ceramic-forming batch mixture or paste. A honeycomb body may comprise an outer peripheral wall, or skin, which was either extruded along with the matrix of walls or applied after the extrusion of the matrix. For example, a honeycomb body can be a plugged ceramic honeycomb structure which forms a filter body comprised of cordierite or other suitable ceramic material. A plugged honeycomb body has one or more channels plugged at one, or both ends of the body.

A honeycomb body disclosed herein comprises a ceramic honeycomb structure comprising at least one wall supporting one or more particulate deposits for example which may be configured to filter particulate matter from a gas stream. The deposits can be in discrete regions or in some portions or some embodiments can form one or more layers of deposit material at a given location on the wall of the honeycomb body. The deposits according to some embodiments comprise inorganic material, in some embodiments organic material, and in some embodiments both inorganic material and organic material. For example, a honeycomb structure of a honeycomb body may, in one or more embodiments, be formed from cordierite or other porous ceramic material and further comprise material deposits disposed on or below wall surfaces of a cordierite honeycomb structure. The inorganic particles are preferably comprised of one or more ceramic or refractory materials.

As used herein, “green” or “green ceramic” are used interchangeably and refer to an unsintered or unfired material, unless otherwise specified.

The methods disclosed herein can be useful in applying a surface treatment to a an article, such as an article comprising porous walls, such as a filter or a particulate filter, which can provide an improved filtering effect, or filtration efficiency, of the particulate filter, such as a filter comprising a bare honeycomb body, or a filter comprising a honeycomb body with other material deposited thereon or therein, such as filtration material deposits, a layer, a membrane, and/or catalytic material.

The methods disclosed herein can be useful in adding like filtration deposits, such as those comprising one or more types of inorganic particles. In embodiments, methods are disclosed herein that can help enable both high filtration efficiency (FE) and low backpressure dP for particulate filters such as gasoline particulate filters. In embodiments, the porous honeycomb body comprises a porous ceramic honeycomb structure, such as a honeycomb body which has been extruded, fired, and provided with a select pattern of plugging or sealing various cells or channels of the honeycomb matrix, including for example a bare honeycomb body which has not yet received other filtration deposits. In various embodiments, such surface treated particulate filter is suitable for filtering exhaust gas from lean burn gasoline direct injection (GDI) engines contain particulate matter such as carbonaceous soot (e.g., soot), i.e. for example, gasoline particulate filters (GPF) with a honeycomb structure for collecting particulate matter in exhaust gases from vehicles equipped with GDI engines.

One approach to manufacturing a suitable GPF high clean filtration efficiency is to deposit filtration deposits or a porous layer of inorganic material on the wall surfaces of the honeycomb matrix of a base (uncoated or undeposited) GPF. In various embodiments an ethanol-based aerosol deposition process can be utilized in which a flow of agglomerated alumina and silica particles is generated by passing ethanol-based alumina-silica suspension through a nozzle or multiple nozzles. The as-deposited filtration material, or in various embodiments as-deposited layer, comprises aggregates of alumina-silica agglomerates with a size in the range of submicrons to a few microns. In such embodiments we found that in the initial deposition some fine agglomerates could penetrate and be trapped inside pores of the base walls or even slip through pores.

We have found that the methods disclose herein provide enhanced durability of the filtration material on honeycomb body, such as after heat exposure and/or higher temperatures, as indicated with excellent filtration performance, and in some embodiments is attainable even at lower filtration material loading compared to other approaches. In embodiments, filter bodies thus produced exhibit high thermal stability and moisture resistance. Furthermore, the methods disclosed herein, in conjunction with the materials used, may be practiced with lower or reduced volatile effluents generated by the deposition process. The methods disclosed herein comprise sol-gel type processing for formulating an alumina-silica suspension.

Methods are disclosed herein providing inorganic deposits, such as oxides, preferably particles of metal oxides, preferably nanoparticles thereof, on a surface, preferably porous surface, of a substrate, preferably porous substrate, the method comprising: combining inorganic particles such as oxide nanoparticles, an organic solvent, a silane binder, and an organic acid such as citric acid into a suspension; aerosolizing at least a portion of the suspension into droplets; evaporating the organic solvent from the droplets to form agglomerates of the particles such as oxide nanoparticles, the organic solvent, the silane binder, and the citric acid from the droplets; depositing the agglomerates onto the substrate; and curing the silane binder on the substrate to form a network of inorganic particles bound to the substrate.

In embodiments, the inorganic particles comprise silicon-containing particles and aluminum-containing particles.

In embodiments, the inorganic particles comprise silica-containing particles and alumina-containing particles.

In embodiments, the inorganic particles consist essentially of silica particles and alumina particles.

In embodiments, the inorganic particles comprise nanoparticles. In embodiments, all of the inorganic particles are nanoparticles.

In embodiments, the curing step comprises hydrolyzing the silane binder and grafting the hydrolyzed silane binder to the inorganic particles. In embodiments, the curing step comprises hydrolyzing the silane binder and hydrolysis products of the silane binder are grafted to the nanoparticles. In embodiments, the grafting creates a cross-linked network of inorganic particles.

In embodiments, the curing is performed in the presence of a curing catalyst. Preferably the curing catalyst is an organic acid. In embodiments, the organic acid is citric acid.

In embodiments, the curing catalyst is present in the suspension. In embodiments, the curing catalyst is present in the droplets. In embodiments, the curing catalyst is present in the agglomerates. In embodiments, the curing step comprises cross-linking the silane binder.

In embodiments, the suspension comprises a catalytic amount of the organic acid. In embodiments, the suspension comprises no more than a catalytic amount of the organic acid.

In embodiments, the curing comprises heating the agglomerates deposited on the substrate. In embodiments, the curing comprises hydrolyzing and grafting the silane binder to the oxide nanoparticles

In embodiments, the organic solvent is an alcohol. In embodiments, the organic solvent is selected from the group consisting of ethanol, methanol, isopropanol, and combinations thereof. In embodiments, the organic solvent comprises ethanol. In embodiments, the organic solvent is ethanol.

In embodiments, the silane binder comprises silane. In embodiments, the silane binder comprises an alkoxysilane (i.e. at least one alkoxysilane), an alkyl alkoxysilane (i.e. at least one alkyl alkoxysilane), or combinations thereof.

In embodiments, the silane binder comprises at least one alkoxysilane. In embodiments, the silane binder comprises at least one methoxysilane, at least one ethoxysilane, or combinations thereof. In embodiments, the silane binder comprises methyltriethoxysilane (MTES), methyltrimethoxysilane (MTMS), or a combination thereof. In embodiments, the silane binder comprises methyltriethoxysilane (MTES). In embodiments, the silane binder is methyltriethoxysilane (MTES).

In embodiments, the droplets are conveyed toward the substrate by a carrier gas. In embodiments, the carrier gas comprises an inert gas. In embodiments, the carrier gas comprises nitrogen. In embodiments, the carrier gas consists essentially of nitrogen.

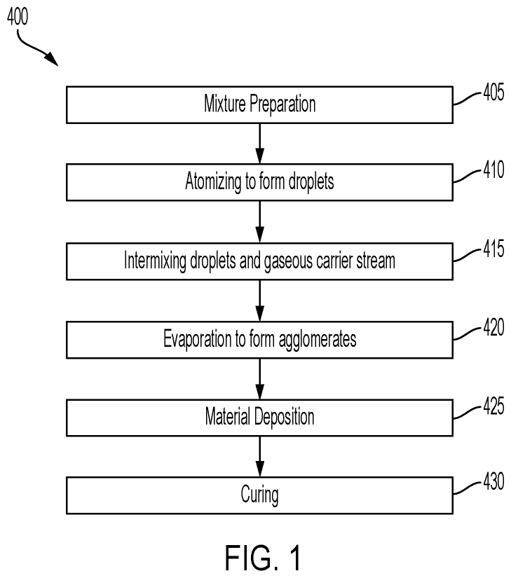

According to one or more embodiments, FIG. 1 schematically illustrates a process of depositing inorganic particles onto a surface, such as the surface of a wall flow filter, wherein the process 400 comprises the steps of suspension, or mixture, preparation 405, atomizing to form droplets 410, intermixing droplets and a gaseous carrier stream 415; evaporating liquid vehicle to form agglomerates 420; depositing of material, e.g., agglomerates, on the walls of a wall-flow filter 425, and post-treatment curing 430 to, for example, bind the deposited inorganic material on, or in, or both on and in, the porous walls of the honeycomb body. Aerosol deposition methods form of agglomerates comprising a binder can provide a high mechanical integrity even without any high temperature curing steps (e.g., heating to temperatures in excess of 1000° C.), and in some embodiments even higher mechanical integrity after a curing step such as a high temperature (e.g., heating to temperatures in excess of 1000° C.) curing step. In the process in FIG. 1, the aerosol deposition forms inorganic material deposits, which in some specific embodiments are porous material deposits. In some embodiments, the material deposits are in the form of discrete regions of filtration material. In some embodiments, at least some portions of the material deposits may be in the form of a porous inorganic layer or membrane.

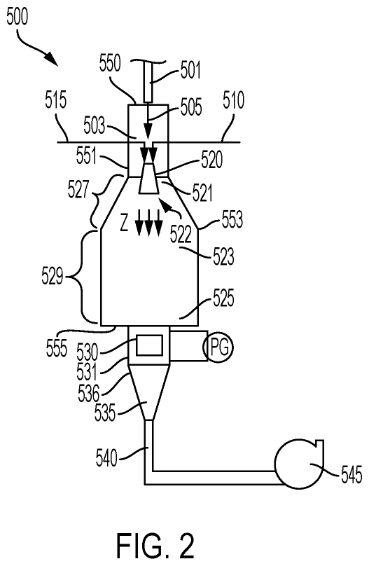

FIG. 2 shows an apparatus 500 for depositing inorganic particles onto honeycomb filter bodies, the apparatus 500 comprising a duct 551, a deposition zone 531, an exit zone 536, an exit conduit 540, and a flow driver 545.

In the embodiment shown, the duct 551 spans from a first end 550 to a second end 555, defining a chamber of the duct comprising: a plenum space 503 at the first end 550 and an evaporation chamber 523 downstream of the plenum space 503. In embodiments, the duct 551 is essentially adiabatic. That is, the duct 551 may have no external sources of heat. The evaporation chamber 523 is defined by an evaporation section 553 of the duct 551, which in this embodiment; comprises a first section of non-uniform diameter 527 and a second section of substantially uniform diameter 529. The evaporation section 553 comprises an inlet end 521 and an outlet end 525. The first section of non-uniform diameter 527 has a diameter that increases from the inlet end 521 toward the section of uniform diameter 329, which creates a diverging space for the flow to occupy.

A carrier gas is supplied to the duct 551 by a conduit 501, which may have a heat source to create a heated carrier gas 505. An atomizing gas 515 and a suspension 510 are separately supplied by individual delivery conduits such as tubing or piping to a nozzle 520, which is at the inlet end 521 of the evaporation section 553 and is in fluid communication with the duct 551, specifically in this embodiment with the evaporation chamber 523. The suspension 510 is atomized in the nozzle 520 with the atomizing gas 515. In one or more embodiments, the suspension 510 can be supplied to the nozzle as a liquid-particulate-binder stream. The liquid-particulate-binder stream is atomized with the atomizing gas 515 into liquid-particulate-binder droplets by the nozzle 520.

In one or more embodiments, the heated carrier gas 505 flows over the nozzle 520. The atomizing gas 515 can be heated to form a heated atomizing gas. Temperature of the nozzle may be regulated as desired.

Outlet flow from the nozzle 520 and flow of the heated carrier gas 505 are both in a “Z” direction as shown in FIG. 2. There may be a diffusing area 522 downstream of the nozzle where at least some intermixing occurs. In this embodiment, the diffusing area 522 is located in the evaporation chamber 523, but in other embodiments, the diffusing area 522 may be located in the plenum space 503 depending on the location of the nozzle.

The outlet flow of from the nozzle intermixes with the heated carrier gas 505, thereby forming a gas-liquid-particulate-binder mixture, which flows through the chamber of the duct 551. Specifically, the gas-liquid-particulate-binder mixture flows through the evaporation chamber 523 of the evaporation section 553 and into the deposition zone 531 at the outlet end 525 of the evaporation section 553. At the intermixing, the gas-liquid-particulate-binder mixture is heated inside the chamber by the heated carrier gas.

In this embodiment, the outlet flow of the nozzle and the heated carrier gas enter the evaporation chamber 523 of the evaporation section 553 from substantially the same direction. In the evaporation chamber 523, substantially all of the liquid vehicle from the droplets is evaporated thereby forming agglomerates of the particles and the binder material, the agglomerates being interspersed in a gaseous carrier stream, which is comprised of the carrier gas and the atomizing gas.

The deposition zone 531 in fluid communication with the duct 551 houses a plugged ceramic honeycomb body 530, for example, a wall-flow particulate filter. The deposition zone 531 has an inner diameter that is larger than the outer diameter of the ceramic honeycomb body 530. To avoid leakage of the gases carrying the ceramic powders, the ceramic honeycomb body 530 is sealed to the inner diameter of deposition zone 531, a suitable seal is, for example, an inflatable “inner tube”. A pressure gauge, labelled as “PG” measures the difference in the pressure upstream and downstream from the particulate filter.

The gas-liquid-particulate-binder mixture flows into the ceramic honeycomb body 530 thereby depositing the inorganic material of the suspension on the ceramic honeycomb body. Specifically, the agglomerates and the gaseous carrier stream pass into the honeycomb body such that the gaseous carrier stream passes through the porous walls of the honeycomb body, and the walls of the honeycomb body trap the agglomerates, wherein the agglomerates and/or aggregates thereof are deposited on or in the walls of the honeycomb body. Upon post-treatment curing the inorganic material binds to the ceramic honeycomb body.

Downstream from the ceramic honeycomb body 530 is an exit zone 536 defining an exit chamber 535. The flow driver 545 is downstream from the ceramic honeycomb body 530, in fluid communication with the deposition zone 531 and the exit zone 536 by way of the exit conduit 540. Non-limiting examples of flow drivers are: fan, blower, and vacuum pump. The aerosolized suspension is dried and deposited on one or more walls of the particulate filter as agglomerates of filtration material, which is present as discrete regions of filtration material, or in some portions or some embodiments as a layer, or both, wherein the agglomerates are comprised of primary particles of inorganic material.

Flow through embodiments such as apparatus 500 is considered in a downward direction, for example, substantially parallel to the direction of gravity. In other embodiments, the apparatus is configured such that flow is directed in a substantially upward or vertical direction.

In embodiments, the agglomerates are spherical. In embodiments, the network of inorganic particles comprises alumina particles and silica particles. In embodiments, the network of inorganic particles forms a membrane on the substrate.

In embodiments, the substrate is a filter body. In embodiments, the agglomerates are deposited on a surface of the filter body by filter deposition. In embodiments, at least some of the agglomerates are disposed below the surface of the filter body. In embodiments, the filter body comprises a honeycomb body comprised of intersecting porous walls, and the surface is a surface of at least one of the porous walls.

In embodiments, the depositing step further comprises filter depositing the agglomerates on, in, or both on and in, a wall of the substrate.

In embodiments, the substrate comprises a plugged honeycomb body comprising intersecting porous walls extending from an inlet end to an outlet end of the body and defining axial channels, wherein plugs seal at least some of the channels, and the depositing step further comprises filter depositing the agglomerates on, in, or both on and in, a plurality of the walls of the honeycomb body.

In embodiments, the inorganic particles have an average BET specific surface area of 200 m2/g or less.

In embodiments, the inorganic particles have an average BET specific surface area of 5 to 200 m2/g.

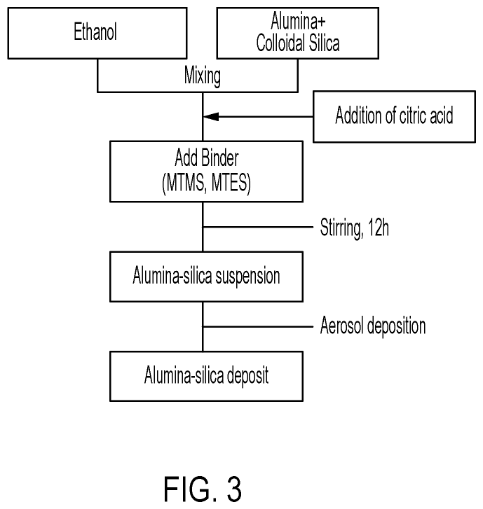

According to one or more embodiments, FIG. 3 schematically illustrates processing steps for forming alumina-silica based deposits on a surface of a substrate, such as a honeycomb body for a gasoline particulate filter. Alumina, such as alumina in suspension, and colloidal silica are mixed with ethanol, to which citric acid is added. Organic binder, such as MTMS and/or MTES, is then added and stirred, for example for 12 hours, then an aerosol is generated from the suspension, and the aerosol is spray dried onto the substrate.

### EXAMPLES

Table 1 lists process conditions used for atomizing a suspension with a nozzle and spraying the atomizing droplets into a carrier gas (drying gas) toward an already-fired plugged porous ceramic honeycomb body for gasoline particulate filters, for embodiments corresponding to Examples 1 and 2 below.

TABLE 1

| | |
|---|---|
| Nozzle pressure [psi] | 78 |
| Suspension flow rate [mL/min] | 5 |
| Solid loading [%] | 11 |
| Total drying gas [Nm³/h] | 60 |

Table 2 lists process conditions used for atomizing a suspension with a nozzle and spraying the atomizing droplets into a carrier gas (drying gas) toward an already-fired plugged porous ceramic honeycomb body (the “part”) for gasoline particulate filters, for embodiments corresponding to Example 3 below.

TABLE 2

| | |
|---|---|
| Atomization flow rate [m³/h] | 7.44 |
| Suspension flow rate [g/min] | 12 |
| Solid loading [%] | 11 |
| Total drying gas [m³/h] | 60 |
| Temperature of spray nozzle [° C.] | 140 |
| Temperature above the part [° C.] | 120 |

### Example 1

An alumina-silica suspension was prepared as shown schematically in FIG. 3. The suspension was prepared by mixing 19.19 parts colloidal silica (LUDOX TMA, 34 wt %), 41.67 parts alumina (30 wt % milled Almatis A1000 alumina in ethanol), 4.1 parts citric acid, 13.28 parts MTMS and 192.42 parts ethanol. The mixture was stirred at room temperature for 12 hours. The suspension was applied to a bare gasoline particulate filter with a diameter of 4.25″ and 4.724″ length using conditions provided in Table 1. The particulate filtration performance of the treated part is provided in Table 3.

### Example 2

Another bare GPF filter from the same batch as employed in Example 1, was coated according to the same procedure used in Example 1, with the exception that the milled Almatis A1000 alumina was replaced with AKP 30 alumina in order to to assess the effectiveness of the silane binder using alumina from different supply sources. The particulate filtration performance of the treated part is provided in Table 3.

### Example 3

In Example 3, an alumina-silica suspension was prepared with 30 wt % milled Almatis A1000 alumina in ethanol as alumina source. The suspension was prepared by mixing 29.41 parts colloidal silica (LUDOX TMA, 34 wt %), 133 parts alumina (30 wt % milled Almatis A1000 alumina in ethanol), 13.14 parts citric acid, 42.50 parts MTMS and 615.74 parts ethanol. The mixture was stirred at room temperature for 12 hours. The suspension was applied to bare gasoline particulate filters with a diameter of 4.25″ and 4.724″ length with the conditions provided in Table 2. The particulate filtration performance of the treated part is provided in Table 4.

TABLE 3
Particulate filtration performance of Examples 1 and 2

| | | Loading | FE-cured | FE-after water test |
|---|---|---|---|---|
| | Alumina type | (g/L) | (%) | (%) |
| Example 1 | milled Almatis | 8.66 | 88.6 | 85.5 |
| | A1000 | | | |
| Example 2 | AKP-30 | 4.98 | 87.8 | 84.1 |

TABLE 4
Particulate filtration performance of GPF samples per Example 3

| | As- | | Curing | Post | Post- | Calcination |
|---|---|---|---|---|---|---|
| | Deposited | Curing | FE | Calcination | water | & Water |
| | FE | FE | Loss | FE | FE | Test FE loss |
| Part # | (%) | (%) | (%) | (%) | (%) | (%) |
| 3-1 | 98.91 | 98.71 | 0.20 | 97.77 | 93.38 | 5.32 |
| 3-2 | 98.63 | 98.14 | 0.50 | 96.98 | 90.71 | 7.43 |
| 3-3 | 99.38 | 99.27 | 0.11 | 98.86 | 97.35 | 1.92 |
| 3-4 | 99.43 | 99.25 | 0.18 | 98.67 | 96.77 | 2.48 |

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method for providing inorganic oxide deposits on a surface of a honeycomb filter substrate, the method comprising:
combining inorganic particles comprising alumina and colloidal silica, an organic solvent, a binder comprising at least one of a methoxysilane or an ethoxysilane, and citric acid as a curing catalyst into a suspension;
aerosolizing at least a portion of the suspension into droplets;
evaporating the organic solvent from the droplets to form agglomerates comprising the inorganic particles, the binder, and the citric acid from;
depositing the agglomerates onto the substrate; and
curing the binder on the substrate to form a network of alumina and silica particles bound to the substrate.

2.-7. (canceled)

8. The method of claim 1, wherein the curing comprises hydrolyzing the binder and grafting the hydrolyzed binder to the inorganic particles.

9.-14. (canceled)

15. The method of claim 1, wherein the curing step comprises cross-linking the binder.

16.-17. (canceled)

18. The method of claim 1, wherein the curing comprises heating the agglomerates deposited on the substrate to a temperature greater than 1000° C.

19.-20. (canceled)

21. The method of claim 1, wherein the organic solvent comprises at least one of ethanol, methanol, or isopropanol.

22.-27. (canceled)

28. The method of claim 1, wherein the binder comprises at least one of methyltriethoxysilane (MTES) or methyltrimethoxysilane (MTMS).

29.-30. (canceled)

31. The method of claim 1, wherein the droplets are conveyed toward the substrate by a carrier gas.

32.-40. (canceled)

41. The method of claim 1, wherein the honeycomb filter substrate comprises a plurality of intersecting porous walls, and the depositing comprises depositing the agglomerates on, in, or both on and in at least some of the intersecting porous walls.

42.-43. (canceled)
